(19) United States
(12) Patent Application Publication
(10) Pub. No.: US 2023/0152774 A1
(43) Pub. Date: May 18, 2023

(54) MACHINE TOOL AND MACHINING METHOD

(71) Applicant: OKUMA CORPORATION, Niwa-Gun (JP)

(72) Inventor: Kazunori FUJISE, Niwa-Gun (JP)

(73) Assignee: OKUMA CORPORATION, Niwa-Gun (JP)

(21) Appl. No.: 18/053,437

(22) Filed: Nov. 8, 2022

(30) Foreign Application Priority Data
Nov. 16, 2021 (JP) 2021-186609

(51) Int. Cl. G05B 19/404

(52) U.S. Cl. CPC G05B 19/404; G05B 2219/41115; G05B 2219/41238

(57) ABSTRACT

A machine tool is configured to machine a workpiece by rotating a tool and/or the workpiece. The machine tool includes a natural frequency changing unit configured to change a natural frequency before machining or during machining in the tool or a supporting portion supporting the tool.

### CROSS REFERENCE TO RELATED APPLICATION

This application claims the benefit of Japanese Patent Application Number 2021-186609 filed on Nov. 16, 2021, the entirety of which is incorporated by reference.

### FIELD OF THE INVENTION

The disclosure relates to a machine tool configured to machine a workpiece into a desired shape, such as a gear, while reducing a chatter vibration, and a machining method using the machine tool.

### BACKGROUND OF THE INVENTION

In a cutting work, a chatter vibration occurs when dynamic characteristics of a machine tool, a tool, and a workpiece and a cutting process satisfy certain conditions, and therefore, it is known that the chatter vibration is reduceable by varying and changing a spindle rotation speed.

For example, as a machining method that reduces the chatter vibration in a gear machining, JP 2018-62056 A proposes a disclosure that reduces the chatter vibration by varying a synchronous rotation speed between a workpiece and a cutter. In JP 2020-78831 A, there is proposed a disclosure that consequently obtains a high quality product using the following procedure. When a chatter vibration occurs, a cutting work is performed with a cutting amount larger than that at the time of the occurrence of the chatter vibration while a rotation speed of a gear cutting tool is accelerated or decelerated, and the machining is performed with the occurrence of the chatter vibration. When a variation amount of a frequency of the gear cutting tool exceeds a predetermined amount, the cutting work is performed again at the rotation speed.

However, in the case of JP 2018-62056 A, since the synchronous rotation speed between the workpiece and the cutter is varied, a machining surface possibly undulates due to an increased error of the synchronous rotation to cause deteriorated machining accuracy.

In the case of JP 2020-78831 A, in order to reduce the chatter vibration, it is necessary to search for an optimum rotation speed by purposely generating a chatter vibration, which possibly causes a damage in the cutting tool.

Therefore, it is an object of the disclosure to provide a machine tool and a machining method configured to reduce a chatter vibration without deteriorating machining accuracy or damaging a tool.

### SUMMARY OF THE INVENTION

In order to achieve the above-described objects, there is provided a machine tool configured to machine a workpiece by rotating a tool and/or the workpiece according to a first configuration of the disclosure. The machine tool includes a natural frequency changing unit configured to change a natural frequency before machining or during machining in the tool or a supporting portion supporting the tool.

In another aspect of the first configuration of the disclosure, which is in the above configuration, the natural frequency changing unit is configured to change the natural frequency before machining by giving anisotropy to a stiffness in a cross-sectional surface direction perpendicular to a tool axis, in the tool.

In another aspect of the first configuration of the disclosure, which is in the above configuration, the stiffness anisotropy is given by forming a plurality of leaf spring portions parallel to one another in the tool.

In another aspect of the first configuration of the disclosure, which is in the above configuration, the natural frequency changing unit is configured to change the natural frequency by changing a stiffness of a rotation shaft by changing a preload to a bearing that supports the rotation shaft on which the tool is mounted in the supporting portion during machining.

In another aspect of the first configuration of the disclosure, which is in the above configuration, the natural frequency changing unit is configured to change the natural frequency by changing a stiffness of the tool by changing a pressure to a pressure chamber disposed in the tool during machining.

In order to achieve the above-described objects, there is provided a method for machining a workpiece using a machine tool configured to machine the workpiece by rotating a tool and/or the workpiece according to a second configuration of the disclosure. The machining method includes machining and changing a natural frequency of the tool or a supporting portion supporting the tool before the machining or during the machining.

With the disclosure, changing the natural frequency of the tool and/or the supporting portion that supports the tool ensures reducing a chatter vibration. Since a synchronous rotation speed between the workpiece and the tool is not varied, the error of the synchronous rotation is decreased, and thus, the machining accuracy is not deteriorated. Furthermore, because of reducing the chatter vibration, the tool is less damaged.

### BRIEF DESCRIPTION OF THE DRAWINGS

FIG. 1 illustrates a configuration of gear machining by a multitasking machine.

FIG. 2A illustrates a cutter that uses a commercially available arbor.

FIG. 2B illustrates a cutter that uses an arbor of the disclosure.

FIG. 3 is a graph that illustrates transfer functions of the cutter.

FIG. 4A illustrates a phase relation between a workpiece and the cutter.

FIG. 4B illustrates a phase relation between a workpiece and the cutter.

FIG. 5A illustrates a machining theory of a chatter vibration reduction.

FIG. 5B illustrates a machining theory of a chatter vibration reduction.

FIG. 6 is a flowchart to determine the number of cutter edges or the number of anisotropic modes of cutter stiffness.

FIG. 7 illustrates another example of a natural frequency changing unit.

FIG. 8 illustrates another example of a natural frequency changing unit.

FIG. 9A illustrates the end mill that uses the commercially available arbor.

FIG. 9B illustrates the end mill that uses the arbor of the disclosure.

FIG. 10A illustrates a machining theory of a chatter vibration reduction of milling machining by the end mill.

FIG. 10B illustrates a machining theory of a chatter vibration reduction of milling machining by the end mill.

### DETAILED DESCRIPTION OF THE INVENTION

The following describes embodiments of the disclosure based on the drawings.

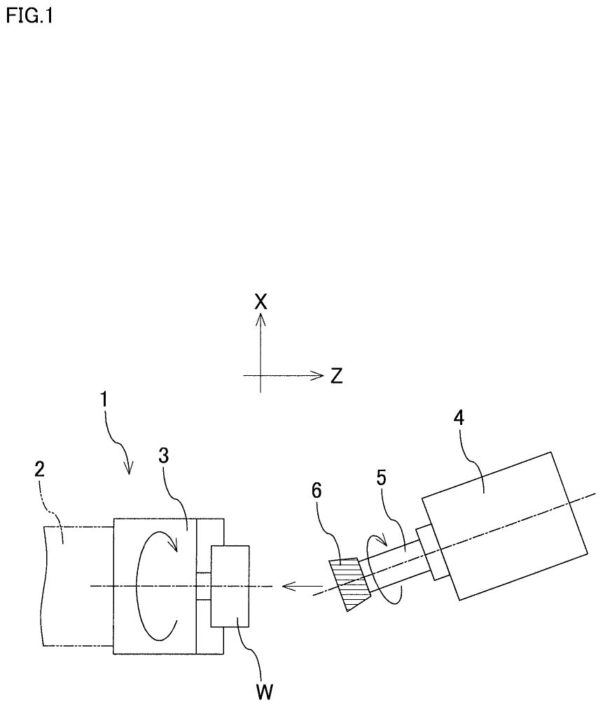

FIG. 1 illustrates a configuration of gear machining by a multitasking machine as one example of a machine tool according to the disclosure. A multitasking machine 1 includes a chuck 3 for holding a workpiece W on a main spindle 2, which is rotatably driven. A cutter 6 is secured in a rotatably driveable manner to a tool post 4 via an arbor 5. The arbor 5 and the cutter 6 are tools of the disclosure.

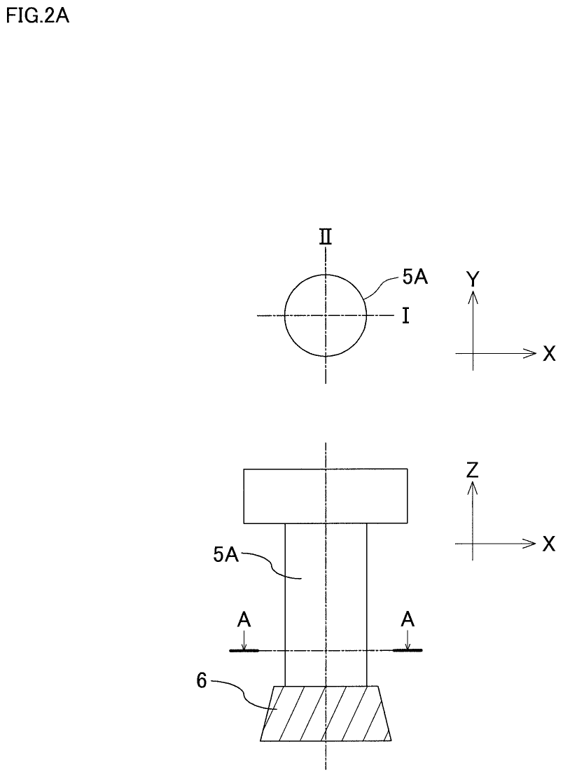

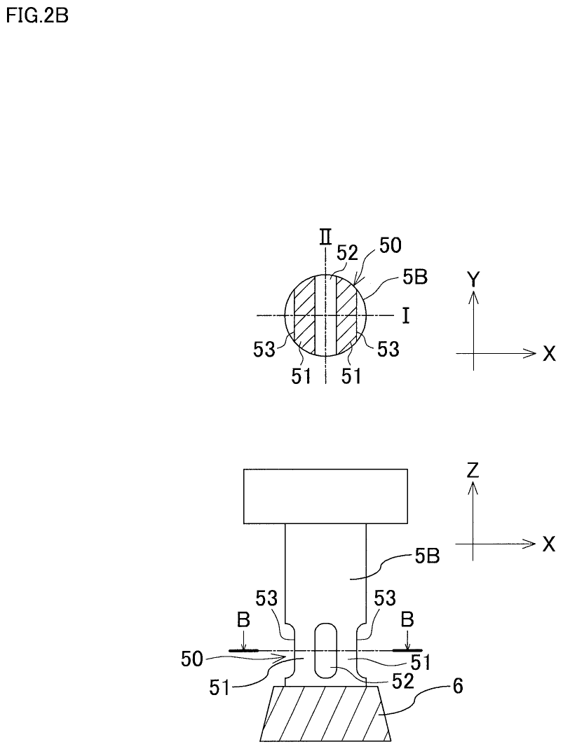

FIGS. 2A and 2B illustrate a structure that gives a stiffness anisotropy to the cutter 6. As illustrated in FIG. 2A, the commercially available arbor 5, hereinafter referred to as “5A”, has a cross-sectional shape on the line A-A that is the same in I-direction and II-direction, and therefore having the same stiffness. Meanwhile, the arbor 5 illustrated in FIG. 2B, hereinafter referred to as “5B”, is provided with a parallel leaf spring structure 50 in a part of a shank portion. The parallel leaf spring structure 50 is formed by disposing a pair of leaf spring portions 51, 51 parallel to one another with a through-hole 52 that passes through in II-direction interposed between the leaf spring portions 51, 51. Each of the leaf spring portions 51 has an outside in I-direction where a depressed portion 53 is formed. The parallel leaf spring structure 50 is thus disposed, thereby causing the arbor 5B to have different cross-sectional shapes on line B-B between I-direction and II-direction, and therefore having different stiffness.

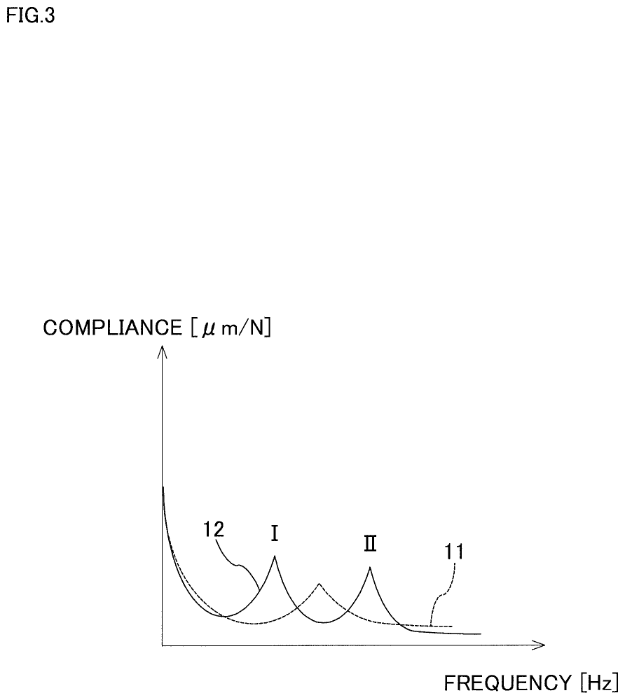

FIG. 3 illustrates transfer functions of the cutter 6. FIG. 3 shows compliance on the vertical axis and frequency on the horizontal axis. A transfer function 11 of the cutter 6 secured to the arbor 5A in FIG. 2A has the same stiffness in I-direction and II-direction, and therefore, there is one natural frequency. The transfer function 11 is indicated by a dotted line in FIG. 3. Meanwhile, a transfer function 12 of the cutter 6 secured to the arbor 5B in FIG. 2B has the different stiffnesses in I-direction and II-direction, and therefore, there are two natural frequencies in I-direction and in II-direction. The transfer function 12 is indicated by a solid line in FIG. 3.

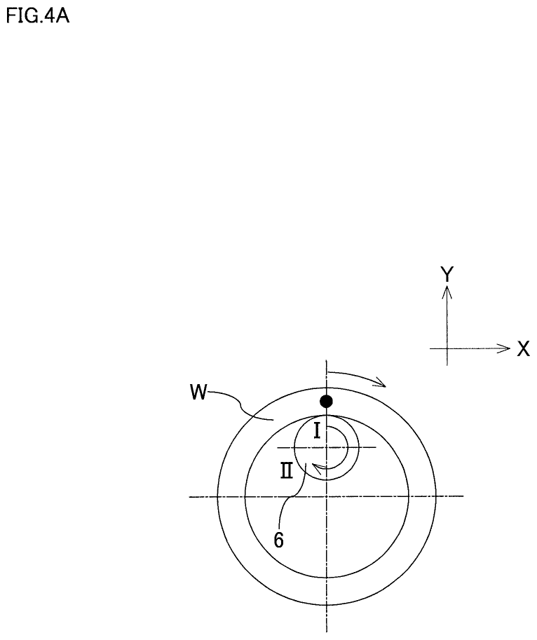

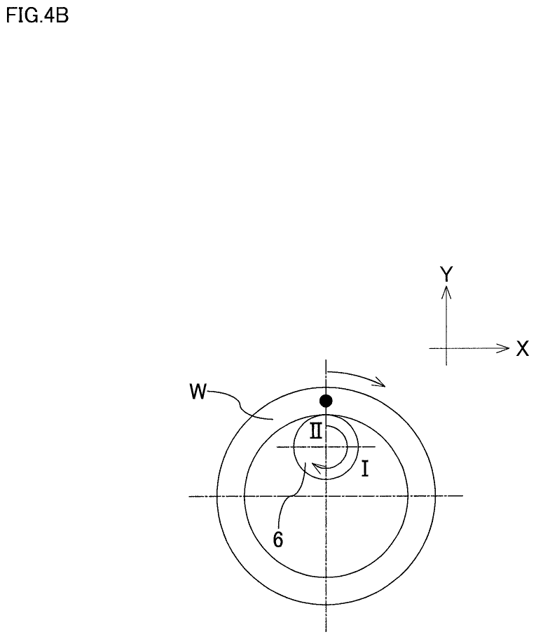

FIGS. 4A and 4B illustrate phase relations between the workpiece W and the cutter 6. When the cutter 6 provided with the parallel leaf spring structure 50 in FIG. 2B performs gear machining, the machining is performed on the workpiece W with the cutter 6 in I-direction at a machining point in one rotation before as illustrated in FIG. 4A. The machining point is indicated by a black spot in FIG. 4A. However, in the case of the workpiece W illustrated in FIG. 4B in one rotation after that illustrated in FIG. 4A, the machining is performed with the cutter 6 in II-direction at the machining point. The machining point is indicated by a black spot in FIG. 4B.

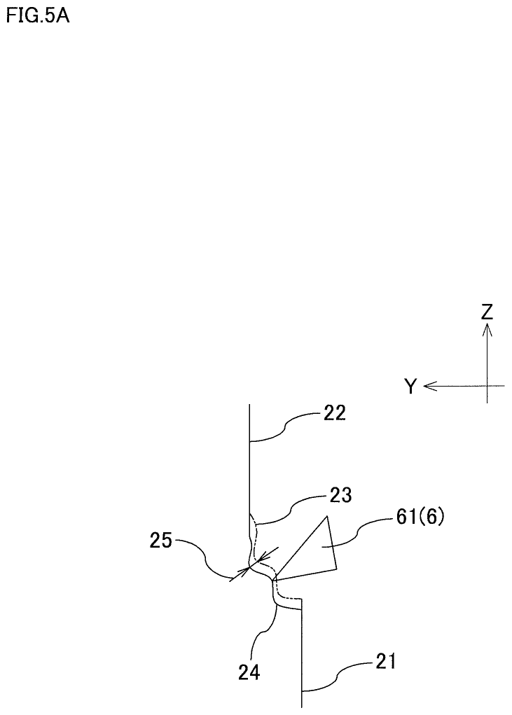

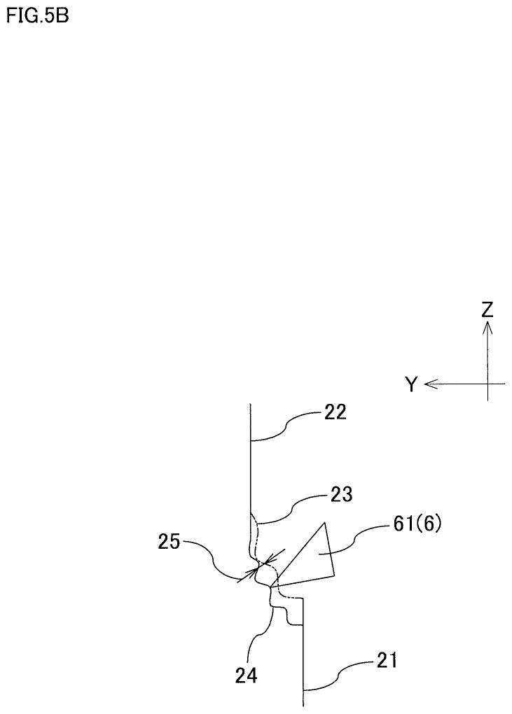

FIGS. 5A and 5B illustrate machining theory of a chatter vibration reduction in the multitasking machine 1. It should be noted that FIGS. 5A and 5B illustrate lateral views of a state of the cutter 6 machining a gear and are situations where a cutter edge 61 is machining from a tooth bottom surface 22 toward a tooth tip surface 21. A distance between a machining surface 23 in one rotation before indicated by a two-dot chain line and a current machining surface 24 indicated by a solid line is an uncut chip thickness 25. When the machining is performed with the cutter 6 of the commercially available arbor 5A as illustrated in FIG. 2A, the natural frequency of the cutter 6 does not change as illustrated in FIG. 5A. Therefore, the machining surface 23 in one rotation before and the current machining surface 24 have unevenness with the same frequency, thereby periodically changing the uncut chip thickness 25, and thus generating a chatter vibration. Meanwhile, when the machining is performed with the cutter 6 of the arbor 5B provided with the parallel leaf spring structure 50 as illustrated in FIG. 2B, the natural frequency of the cutter 6 changes as illustrated in FIG. 5B. Therefore, the machining surface 23 in one rotation before and the current machining surface 24 have unevenness with different frequencies, thereby making the uncut chip thickness 25 irregular, and thus reducing the chatter vibration.

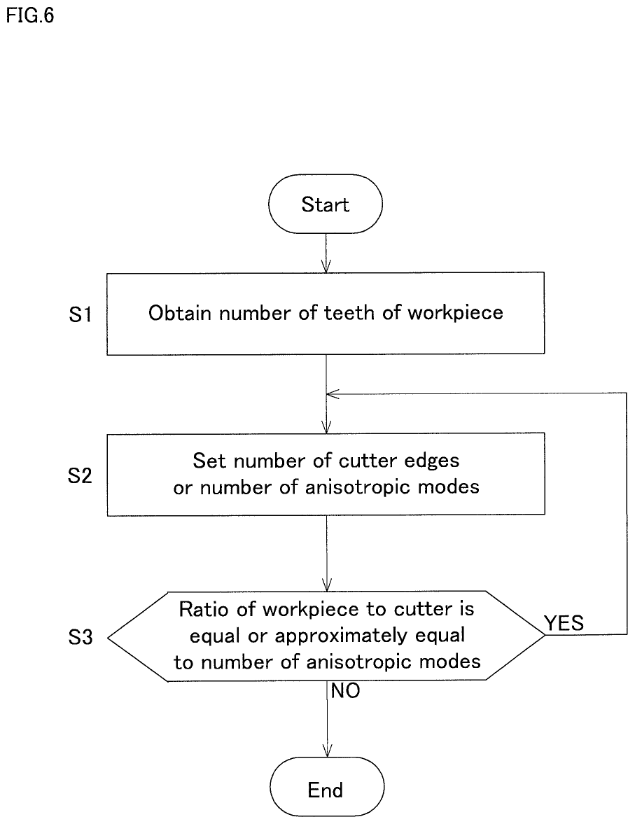

When the above-described parallel leaf spring structure 50 is employed, in order to enhance the reduction effect of the chatter vibration, it is preferred to determine the number of edges of the cutter 6 or the number of anisotropic modes so as to avoid the ratio of the number of teeth of the workpiece W to the number of edges of the cutter 6 from matching the number of anisotropic modes. FIG. 6 is a flowchart to determine the number of edges of the cutter 6 or the number of anisotropic modes of the cutter stiffness.

First, at step (hereinafter referred to as “S”) 1, the number of teeth of the workpiece W is obtained. At S2, the number of edges of the cutter 6 or the number of anisotropic modes is determined. At S3, a ratio of the number of teeth of the workpiece W to the number of edges of the cutter 6 is compared with the number of anisotropic modes. When the two are equal or when the two are approximately equal, the procedure returns to S2, and the number of edges of the cutter 6 or the number of anisotropic modes are reconfigured. When the two are not equal or when the two are not approximately equal, the procedure is terminated.

Thus, with the multitasking machine 1 and the machining method in the above-described configuration, in the machine tool configured to machine the workpiece W by rotating the tool formed of the arbor 5B and the cutter 6 and the workpiece W, the arbor 5B of the cutter 6 is provided with the parallel leaf spring structure 50, which is a natural frequency changing unit, configured to change the natural frequency before the machining Thus, the chatter vibration is reduceable without deteriorating the machining accuracy or damaging the tool.

In particular, the natural frequency changing unit is configured to change the natural frequency before the machining by giving anisotropy to the stiffness in a cross-sectional surface direction perpendicular to a tool axis, in the arbor 5B. Therefore, the natural frequency can be easily changed using the arbor 5B.

The stiffness anisotropy is given by forming the leaf spring portions 51, 51 parallel to one another in the arbor 5B, and therefore, the anisotropy is easily given by forming the leaf spring portions 51, 51.

The following describes modification examples of the disclosure.

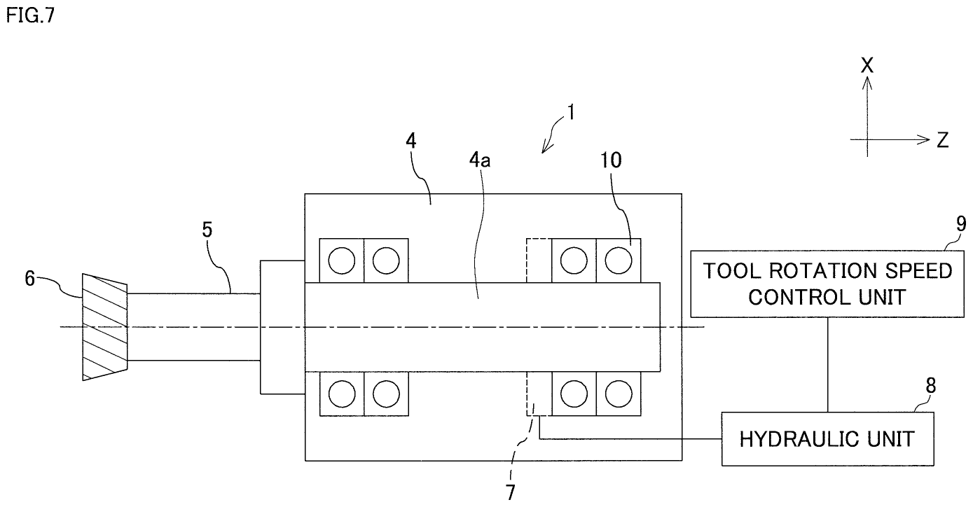

FIG. 7 illustrates a structure in which the natural frequency changing unit is disposed in the tool post 4 as the supporting portion on which the arbor 5 is mounted in the multitasking machine 1. Here, a hydraulic chamber 7 is disposed on a portion of a rotation shaft 4a in the tool post 4. A hydraulic unit 8 pressurizes and depressurizes the hydraulic chamber 7 to change a preload of a rolling bearing 10, and thus, the stiffness of the rotation shaft 4a is changed during machining, thereby allowing to change the natural frequency. The change of the natural frequency is performed by calculating a cycle of the pressurization and depressurization based on a rotation speed command from a tool rotation speed control unit 9 and controlling the hydraulic unit 8.

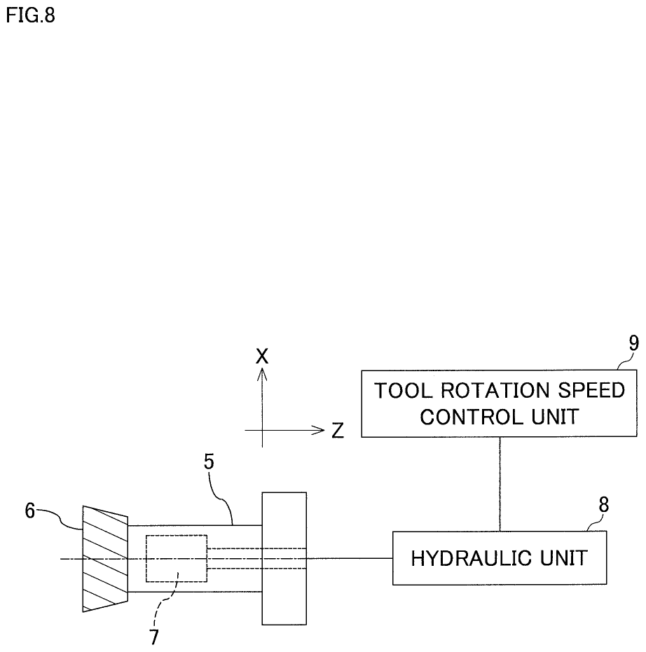

FIG. 8 illustrates a structure in which the natural frequency changing unit is disposed in the arbor 5. Here, the hydraulic chamber 7 is disposed in a shank portion of the arbor 5. The hydraulic unit 8 pressurizes and depressurizes the hydraulic chamber 7 to change the number of anisotropic modes of the stiffness in the cutter 6 during machining, thereby allowing to change the natural frequency. The change of the natural frequency is performed by calculating a cycle of the pressurization and depressurization based on a rotation speed command from the tool rotation speed control unit 9 and controlling the hydraulic unit 8.

The disclosure is not limited to the machining that rotates the tool and the workpiece together as the above-described configuration.

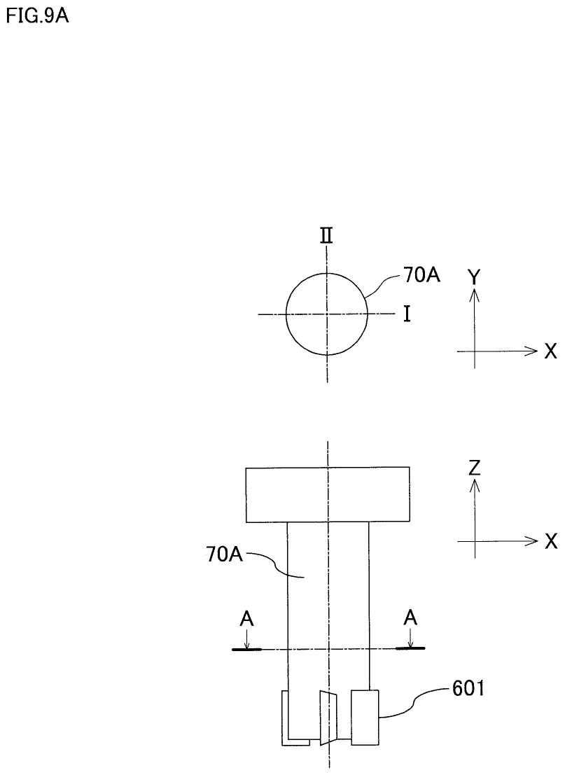

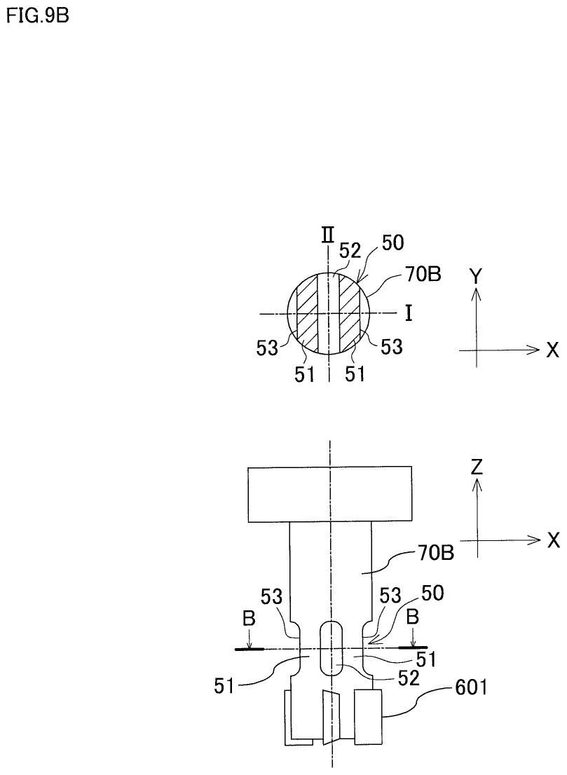

FIGS. 9A and 9B illustrate structures in which the natural frequency changing unit is disposed in an end mill as the tool. As illustrated in FIG. 9A, a commercially available end mill 70, hereinafter referred to as “70A”, has a cross-sectional shape on the line A-A that is the same in I-direction and II-direction, and therefore having the same stiffness. Meanwhile, as illustrated in FIG. 9B, an end mill 70, hereinafter referred to as “70B”, is provided with the parallel leaf spring structure 50 similar to that of the arbor 5B in a part of a shank portion, thus having different cross-sectional shapes on the line B-B between I-direction and II-direction, and therefore having the different stiffness.

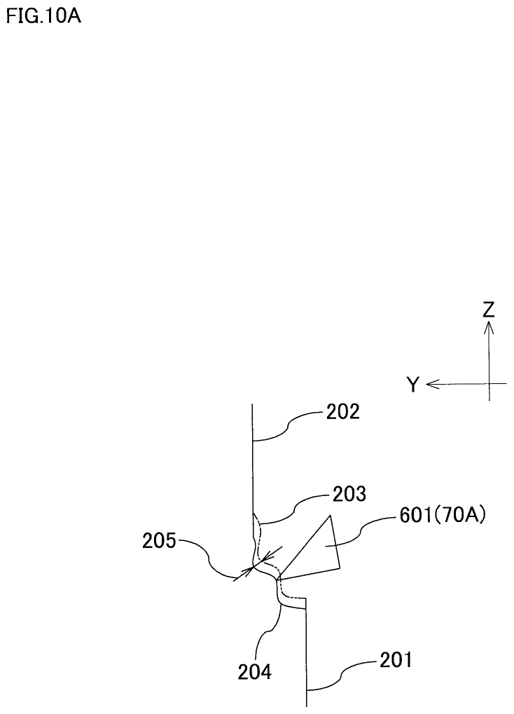

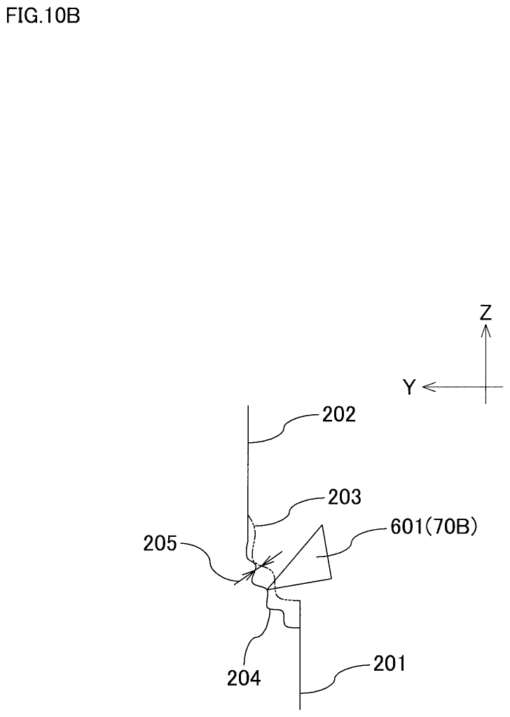

FIGS. 10A and 10B illustrate machining theory of a chatter vibration reduction of milling machining. It should be noted that FIGS. 10A and 10B illustrate top views of a state where the end mill machines a side surface of the workpiece W and are situations where a tool cutting edge 601 is up-cutting or down-cutting from a finish surface 202 toward a material surface 201. A distance between a machining surface 203 of one cut before indicated by a two-dot chain line and a current machining surface 204 indicated by a solid line is an uncut chip thickness 205.

When machining is performed with the end mill 70A, the natural frequency of the end mill 70A does not change. Therefore, as illustrated in FIG. 10A, the machining surface 203 of one cut before and the current machining surface 204 have unevenness with the same frequency, thereby periodically changing the uncut chip thickness 205, and thus generating a chatter vibration. Meanwhile, when the machining is performed with the end mill 70B provided with the parallel leaf spring structure 50, the anisotropy is given to the stiffness, and the natural frequency of the end mill 70B changes. Therefore, the machining surface 203 of one cut before and the current machining surface 204 have unevenness with different frequencies as illustrated in FIG. 10B, thereby making the uncut chip thickness 205 irregular, and thus reducing the chatter vibration.

Note that, in the arbor 5B and the end mill 70B in the above-described configurations, the parallel leaf spring structure is not limited to the above-described structure. For example, there may be three or more leaf spring portions, instead of a pair of them, or the outside depressed portion may be eliminated.

The above-described configurations include the example of machining with the tool and the workpiece being rotated and the example of machining the workpiece with the tool being rotated. However, the disclosure is applicable also to the configuration that fixes the workpiece to the rotation shaft and the machining is performed without rotating the tool. Accordingly, the workpiece is not limited to a gear.

A plurality of the natural frequency changing units can be employed. For example, a combination is also conceivable in which the hydraulic chamber that changes a preload of the bearing is disposed in the tool post while the parallel leaf spring structure and the hydraulic chamber are disposed in the tool to allow to give the stiffness anisotropy.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A machine tool configured to machine a workpiece by rotating a tool and/or the workpiece, the machine tool comprising
a natural frequency changing unit configured to change a natural frequency before machining or during machining in the tool or a supporting portion supporting the tool.

2. The machine tool according to claim 1, wherein
the natural frequency changing unit is configured to change the natural frequency before machining by giving anisotropy to a stiffness in a cross-sectional surface direction perpendicular to a tool axis, in the tool.

3. The machine tool according to claim 2, wherein
the stiffness anisotropy is given by forming a plurality of leaf spring portions parallel to one another in the tool.

4. The machine tool according to claim 1, wherein
the natural frequency changing unit is configured to change the natural frequency by changing a stiffness of a rotation shaft by changing a preload to a bearing that supports the rotation shaft on which the tool is mounted in the supporting portion during machining.

5. The machine tool according to claim 1, wherein
the natural frequency changing unit is configured to change the natural frequency by changing a stiffness of the tool by changing a pressure to a pressure chamber disposed in the tool during machining.

6. A method for machining a workpiece using a machine tool configured to machine the workpiece by rotating a tool and/or the workpiece, the machining method comprising:
machining; and
changing a natural frequency of the tool or a supporting portion supporting the tool before the machining or during the machining.
